(19) United States
(12) Patent Application Publication
(10) Pub. No.: US 2017/0250930 A1
(43) Pub. Date: Aug. 31, 2017

(54) INTERACTIVE CONTENT RECOMMENDATION PERSONALIZATION ASSISTANT

(71) Applicant: Outbrain Inc., New York, NY (US)

(72) Inventor: Yuval Ben-Itzhak, Nebusice (CZ)

(21) Appl. No.: 15/403,699

(22) Filed: Jan. 11, 2017

Related U.S. Application Data
(60) Provisional application No. 62/301,265, filed on Feb. 29, 2016.

(51) Int. Cl. H04L 12/58; G06F 3/0488; G10L 15/22; G06F 17/30

(52) U.S. Cl. CPC H04L 51/02; G06F 17/30702; G06F 3/04886; G06F 3/04883; G10L 15/22; G06F 17/279

(57) ABSTRACT

An interactive communication-based personalized content recommendation provisioning method and system are described. A user interacting with an interactive communication platform (e.g., a messaging application, an Internet of Things device, a Virtual Reality device, an Augmented Reality device, a webpage, a website etc.) may engage in an interactive conversation (e.g., a text-based exchange, a voice-based exchange, a video-based exchange, a gesture-based exchange etc.) with a conversation agent of a personalized content recommendation communication system. The user may interact with the conversation agent via a conversational exchange of messages to receive one or more content recommendations that are tailored to or “personalized” for that user. The personalized content recommendations may be provided by the conversation agent via a message as part of the conversation with the user.

### CROSS-REFERENCE TO RELATED APPLICATION

This application claims the benefit of U.S. Provisional Application No. 62/301,265, filed on Feb. 29, 2016, the entirety of which is hereby incorporated by reference herein.

### TECHNICAL FIELD

The present disclosure relates to content recommendation networks, and more particularly, to an interactive content recommendation personalization communication assistant engaging in interactions (e.g., conversations) with users to identify appropriate content recommendations to provision to users in an electronic environment.

### BACKGROUND

In the digital content or any service industry, it is desirable for a content or service provider (e.g., a website publisher, a car manufacturer etc.) to present users with “recommended” content. In this regard, it is a goal to provision personalized content recommendations that are interesting, trustworthy, and relevant to the user. This will have the effect of increasing the user's consumption of the recommended content, achieving a higher level of user engagement with the content and services provided, and increasing the content or service provider's revenue.

In a real life interaction between two people, a first person may try to understand the other person's interests, preferences, views, personality, mood and likes before recommending something to that person. However, in an electronic environment, gaining an understanding of a person in order to generate recommendations of content likely to match the interests of a user and result in a positive engagement by the user is a difficult challenge.

### BRIEF DESCRIPTION OF THE FIGURES

The present disclosure will be understood more fully from the detailed description given below and from the accompanying drawings of various implementations of the disclosure.

FIG. 1 illustrates an example system architecture in which examples of the present disclosure can be implemented.

FIG. 2 is a flow diagram of an implementation of a method for serving personalized content recommendations in an interactive communication environment, including loading a user session for a user, in accordance with various implementations.

FIG. 3 is a flow diagram of an implementation of a method for serving personalized content recommendations in an interactive communication environment, including an onboarding process, importing user session data, and providing a content recommendation to a user, in accordance with various implementations.

FIG. 4 is a flow diagram of an implementation of a method for serving personalized content recommendations, in accordance with various implementations.

FIG. 5 is a flow diagram of an implementation of a method for generating content recommendation scopes for users, in accordance with various implementations.

FIG. 6 is an exemplary screenshot of a content recommendation widget (pre-registration), in accordance with various implementations.

FIG. 7 is an exemplary screenshot of a content recommendation webpage frame or content tile, in accordance with various implementations.

FIG. 8 is an exemplary screenshot of a content recommendation personalization hub front page, in accordance with various implementations.

FIGS. 9A-9C illustrate screenshots of exemplary content recommendation personalization interfaces, in accordance with various implementations.

FIG. 10 is a block diagram of an example computer system that may perform one or more of the operations described herein, in accordance with various implementations.

### DETAILED DESCRIPTION

An interactive communication-based personalized content recommendation provisioning method and system are described, according to various implementations. In an implementation, a user interacting with an interactive communication platform (e.g., one or more messaging applications (e.g., a text platform), a chat platform, a video platform, a voice-controlled personal assistant application, an Internet of Things (TOT) device, a virtual reality (VR) device, an augmented reality (AR) device, etc. may engage in an interaction including a conversation (e.g., a text-based exchange, a voice-based exchange, a video-based exchange, a gesture-based exchange, or a combination thereof) with one or more conversation agents (e.g., artificial intelligence (AI) agents or rules-based conversation agents) of a personalized content recommendation communication system (also referred to as a “Chatbot system”). The user may interact with the conversation agent via a conversational exchange of messages in various formats (e.g. text, voice, video, gestures, or a combination thereof) to receive one or more content recommendations that are tailored to or “personalized” for that user.

In an example, a user may initiate a conversation with a first conversation agent via an interactive communication platform. Using a typical conversational tone, format, and structure, the user may communicate one or more signals to the conversation agent via an active interaction or conversation that are indicative of one or more of the user's interests, preferences, requests, views, personality, mood, dislikes, likes, etc. These conversation signals associated with the user and their active conversation may be collected and analyzed by a personalized content recommendation system to generate one or more personalized content recommendations to provide to the user via the interactive communication platform as part of the active conversation. The user signals may represent any element of information provided by the user that may be used to generate a user profile associated with the user, compile or update an existing user profile associated with the user, identify or relate an existing user profile associated with the user, or a combination thereof. The user profile is stored and may be modified, changed, augmented, and expanded over time in view of the user's activities (e.g., interactions with previously provided content recommendations, web-based history, purchasing history, search history, etc.) and conversation history between the user and the conversation agent. Collection and expansion of the user profile based on the user's activity history and conversations between the user and the conversation agent results in the generation of a robust and comprehensive profile for the user that may be used to identify and provide refined, user-specific (e.g., personalized) content recommendations to that user.

In an implementation, the user is presented with the personalized content recommendation as a communication integral to an active conversation with the conversation agent. For example, a Uniform Resource Locator (URL) link may be provided by the conversation agent to the user as a message or response to the one or more user messages in the active conversation. In this example, the user may interact with the provided URL link associated with the personalized content recommendation to access and consume the recommended content. According to implementations of the present disclosure, the personalized content recommendation may be provided to a user in any suitable form or format including, but not limited to, an audio message (e.g., a voice message), an image, a video, a VR interaction, an AR interaction, a link to a different interactive communication platform, etc.). Appropriate natural language or other messages (e.g. text, audio, emoji etc.) may accompany and contextualize the content recommendations provided to each unique user during the course of a conversation session.

Advantageously, the personalized content recommendation may be provided based on and as part of the active conversation and message exchange with the user. To this end, the user may engage in a conversation having a familiar, interactive, free-form, and spontaneous interaction (e.g., dialog) with the conversation agent (e.g., as the user would interact with his or her friend via a conventional text, voice or video message exchange) to cause the provisioning of one or more personalized content recommendations to the user via the interactive communication platform interface as part of the active dialogue.

In an implementation, the dialog between the user and the conversation agent is executed using an AI engine to enable an automated conversation. The personalized content recommendation system receives the one or more messages (e.g., text, voice, video, gesture, etc.) from the user in an active conservation or user session and generates one or more personalized content recommendations.

In an implementation, the conversation agent provides further prompts and/or dialogue to engage the user and collect user signals. Since the system-side messaging is automated, the personalized content recommendation communication system can support and scale to any number of users. According to implementations of the present disclosure, the conversation agent and associated conversation engine (e.g., an AI engine or a rules-based engine) can be implemented by using any suitable AI-based or rules-based communication system, method, instructions, logic, platform, and techniques.

In an embodiment, a rule-based engine is used to plan, conduct and manage conversations with users of the Chatbot system provided on the messaging platform. A rule-based engine can be implemented using various programming methods such as user response text databases or graphical logic tree configuration systems known in the art.

In an implementation, a graphical logic tree configuration system can be used to map out and manage various possible user conversation paths in response to various user action triggers. In an implementation, the configuration scripts can take the logical form of “if a user does or chooses this action, then respond with this action”. In such a configured environment, user actions can set off a sequence or path of triggered actions that respond interactively to the user's input. Such trigger events or nodes with a user action path script can include: a keyword input by the user, user intents abstracted from and mapped to content categories from user keyword inputs (e.g., the abstracted intents Greet, Like, Dislike, Discover, Trending, Emoji, Category, Topic etc.), or simple search results in response to a specific user input string or command. In an implementation, user intent mapping can be performed using an amalgamation of various Natural Language Processing (NLP) techniques known in the art.

The pre-configured tree flow paths or scripts can also provide a variety of configurable user action trigger choices or options. These may include: keyword or input action buttons (e.g., “Like”, “Related”, “Summary” etc.), different content tile types (e.g., a content recommendation, quiz, poll etc.), flows between different content recommendation tiles, push notifications (e.g., a “Breaking News” notification bringing the user to the start of a new conversation path).

In an implementation, a user profile is established for each of the multiple users interacting with the personalized content recommendation communication system via an electronic environment (e.g., via a web-based environment, an application-based environment, etc.). The user profile may include information relating to a user including, but not limited to, information associated with the one or more user's communication sessions with the conversation agent, information identifying content consumed by the user (e.g., previously provisioned recommendations and clicks thereon, web browsing history, purchasing activity, etc.) based at least in part on information collected from the user's messaging session(s) with one or more conversation agents (collectively referred to as the “user activity”). In an implementation, the user profile can also include user-related data provided by the interactive communication platform, one or more web services, one or more applications stored and executed on one or more electronic devices associated with the user, or by any other third party network that employs user-related information (e.g., a third party user profile) to authenticate or identify the user. In an implementation, the web-based activity (e.g., browsing history) of the user including the consumption of content recommendations received from the personalized content recommendation communication system may be tracked, captured, and monitored by an associated tracking mechanism, such as a cookie or pixel. The multiple user profiles associated with the user (e.g., user profiles associated with the one or more interactive communication platforms, web services, applications, etc.) may be used to map and store aggregated data relating to user content consumption activities, interests, user conversations on the interactive communication platforms, and preferences across multiple content networks.

A unique identifier may be associated with a user as it relates to the interactive communication platform (herein referred to as the “interactive communication platform ID”). For example, the interactive communication platform ID may include a username of the user issued by the interactive communication platform (e.g., the user's Kik identifier, the user's Telegram identifier, the user's Viber identifier, the user's WhatsApp identifier, etc.) The interactive communication platform ID may be used by the interactive communication platform to identify a user and track the user's activity with respect to the interactive communication platform (e.g., historical messaging records including previous messaging sessions, a log of messages sent and received by the user, etc.) The information associated with the interactive communication platform ID may be maintained in a user profile associated with the user (herein the “interactive communication platform user profile”).

In addition, a unique identifier may be associated with the user as it relates to the personalized content recommendation communication system (herein referred to as the “recommendation communication system ID” or “Chatbot ID”). For example, the personalized content recommendation communication system 100 may assign a unique identifier to each user of the system to use for tracking purposes, as described in greater detail below.

In addition, the user may be associated with one or more third party application, platform, device, system, or network IDs (e.g., one or more social network identifiers, one or more customer identifiers, one or more application identifiers, etc.), collectively referred to as “related systems”. In an implementation, the related systems may each maintain a user profile associated with a respective user (herein referred to as a “related system ID”).

According to implementations of the present disclosure, a user may be associated with multiple user identifiers (e.g., the one or more interactive communication platform IDs, the content recommendation communication system ID, the content recommendation system ID, and one or more related system IDs). The multiple IDs associated with a user may be linked or associated with one another in the personalized content recommendation communication system, such that the user information associated with the multiple IDs may be linked, accessed, and aggregated.

In an implementation, the interactive communication platform and/or the personalized content recommendation communication system may encounter a “cold start” problem, wherein the system does not include a “native” user profile including historical information relating to a user currently interacting with it (e.g., an existing unique user ID or user profile), herein referred to as the “Chatbot user profile”. In this implementation, the user may be prompted to provide information or permission to allow the Chatbot system to access his or her related system ID and one or more user profiles maintained by another system, network, application, platform, or device (herein referred to as a “related profile”). In an embodiment, the user interacting with the interactive communication platform or the personalized content recommendation interactive communication platform is automatically prompted to provide information that may be used to identify the user and gain access to the one or more related user profiles maintained by one or more related systems. For example, the user may be prompted to provide a voice sample via an interface of the interactive communication platform (e.g., “system A”). In an implementation, the voice sample may analyzed and converted into a dynamically generated, time-bound character string by system A (or the personalized content recommendation communication system) used to authenticate the user and gain access to the user's related user profile maintained by a related system (e.g., “system B”). The voice sample (e.g., one or more phrases or keywords) provided by the user is converted into a string and used by system A to query a user ID database of system B to identify one or more corresponding matches. Upon identifying one or more matches in system B, the corresponding user profile is provided by system B to system A for use in interacting with the user via system A, as described in detail below.

In an implementation, a user may be “acquired” from a third party system (e.g., a web-based system, another application, etc.) into the personalized content recommendation communication system 100. A user ID from the third party system (i.e., the related profile) may be sent to or otherwise obtained by the personalized content recommendation interactive communication platform 100 at the time a user is on-boarded. The related profile may be linked to the Chatbot profile, thereby avoiding the “cold start” challenge. In an example, a user having a related profile relating to an existing Web widget with which the user interacts, may allow access to and use that related profile.

In an implementation, information relating to a user may be collected and aggregated from multiple different user profiles (e.g., a user profile of the personalized content recommendation system and one or more related system) to form a primary user profile maintained by the personalized content recommendation communication system (herein the “primary user profile” or “Chatbot user profile”). According to implementations of the present disclosure, the personalized content recommendation system and interactive communication platform may not have direct access to a related profile maintained by a related system. In this example, the personalized content recommendation system or interactive communication platform may interface with the related system via one or more application program interfaces (APIs) to send and receive information from the related system, including the related ID and the related user profile.

In an implementation, a content database may be established including multiple sets of content candidates from one or more content sources. The sets, also referred to as “candidate content recommendation pools” may be associated with a measurement of user trust (also referred to as a “long-term user trust measure”). In an implementation, the system may include a module (herein the “personalized content recommendation system”) configured to analyze the user messaging session information (e.g., information relating to the user's conversations via the one or more interactive communication platforms) and the one or more user profiles to identify or generate one or more personalized content recommendations for the user to be provided to the user via the interactive communication platform or personalized content recommendation interactive communication platform. In an implementation, the personalized content recommendation system may further consider one or more content recommendation scopes in identifying or generating the one or more personalized content recommendations for a user.

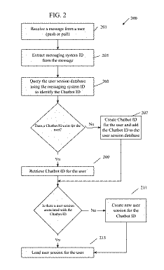

The personalized content recommendation system may be a software component (e.g., a set of instructions residing in a memory) executable by one or more processing devices to perform the personalized content recommendation generating activities described herein (e.g., the methods described in detail in connection with FIGS. 2-5).

According to the present disclosure, content recommendations can be personalized for every individual user by using available relevant implicit and explicit user data such as user message keywords, keyword filters, user search keywords, user browsing history, user profile data, user device usage data, voice commands, facial expressions, physical gestures, user biometric data etc.

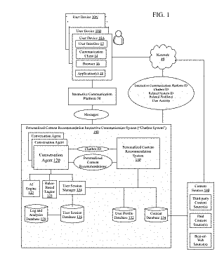

FIG. 1 illustrates an example electronic environment in which examples of the present disclosure can be implemented. The electronic environment can include one or more user devices 10 (e.g., user device 10A, user device 10B, through user device 10N), a personalized content recommendation interactive communication platform 100, one or more interactive communication platforms 50, and one or more content sources 140 coupled to each other over one or more networks 40.

Content sources 140 may have content (e.g., content recommendations) they wish to have displayed, for example, via the interactive communication platforms 50. For example, a content source 140 may have multiple candidate content recommendations that the content source makes available for provisioning to a target user via the interactive communication platforms 50 in the context of a conversation between the target user and one or more conversation agents 120 of the personalized content recommendation interactive communication platform 100.

According to implementations, multiple conversation agents 120 may be maintained by the Chatbot system 100. The individual conversation agents 120 may be configured to provide interactions with users on behalf of a particular publisher (e.g., CNN, ESPN, etc.) or a particular topic (e.g., baseball, politics, fashion, etc.) or on the basis of any other content processing criteria. In this regard, a publisher-specific Chatbot or topic-specific Chatbot may be generated and made available for subscription by the one or more users. For example, a user may elect to subscribe to a CNN Chatbot, wherein the user engages in interactions (e.g., conversations) with a conversation agent configured to converse and provide recommendations relating to the information and content served by the CNN publisher. Furthermore, the Chatbot system 100 may provide a content recommendation which includes an invitation, suggestion, recommendation, and/or link to subscribe to a publisher-specific or topic-specific Chatbot, depending on the interests identified for that user. In this regard, different Chatbots and their associated conversation agents may be “nested” as part of a recommendation provided by the Chatbot system 100.

According to implementations of the present disclosure, the interactive communication platform 50 may be an application 18 executable by the user device (e.g., Kik, Telegram, Viber, WhatsApp, Apple Messages, etc.) or a program executed by a web server (e.g., an interactive interface presented as a portion of a web page. For example, a website publisher (e.g., CNN) may include an interactive communication platform 50 as a part of the publisher's web page.

A candidate content recommendation can be a representation of digital content. Digital content can include and is not limited to items such as an article, a web blog entry, a social media posting, a data feed, an advertisement, a document (e.g., webpage), digital video, digital movies, digital photos, digital music, social media updates, electronic notifications, electronic books (e-books), electronic magazines, digital newspapers, digital audio books, electronic journals, electronic comic books, software applications, virtual or augmented reality environments, real-time data visualizations, etc. Each content source can have multiple candidate content recommendations considered by a personalized content recommendation system 130 of the Chatbot system 100 as a candidate for provisioning via the interactive communication platform to one or more target users. A content database 134 may be used to store candidate content recommendations received from the content sources 140. As used herein, the term “database” may include any suitable memory, such as, for example, one or more cache storage units, one or more persistent storage units, etc. A persistent storage unit can be a local storage unit or a remote storage unit. Persistent storage units can be a magnetic storage unit, optical storage unit, solid-state storage unit, electronic storage unit (main memory), or a similar storage unit. Persistent storage units can be a monolithic device or a distributed set of devices. A “set,” as used herein, refers to any positive whole number of items.

According to implementations, a user operating a user device 10 engages in a conversation or exchange of messages with a conversation agent 120 of the Chatbot system 100 via an interactive communication platform 50. The user device 10 may launch and interact with the interactive communication platform 50 via communication client 14 installed on the user device 10 or via a browser 16 of the user device 10. The interactive communication platform 50 and the Chatbot system 100 may communicate via one or more APIs using a push/pull communication methodology. Although for exemplary purposes a single interactive communication platform 50 is illustrated in FIG. 1, any number of interactive communication platforms or systems may be used. Like a conventional user, the conversation agent 120 is associated with a username or identifier on the interactive communication platform 50 which may be used by the user to address his or her messages to the conversation agent 120. Since any suitable interactive communication platform 50 may be employed (e.g., Kik, Telegram, Viber, WhatsApp, etc.), the conversation agent 120 may have an identifier associated with each of the interactive communication platforms or systems. In an implementation, the username or identifier associated with the conversation agent 120 may be managed like a “contact” in a user's contact list.

In an implementation, the user device 10 initiates a session with the interactive communication platform 50 and addresses a communication to the identifier associated with the conversation agent 120. The conversation agent 120 is operatively coupled to an AI engine 122 and/or a Rules-Based engine 123 configured to receive messages from the user device 10, analyze the received messages, and transmit a contextually appropriate response to the user device 10. It is noted that any suitable AI or rules-based engine configured to receive and analyze user input text, audio, video, gestures or biometric data (e.g., the messages from the user device 10) and formulate a response based thereon may be employed.

The Chatbot system 100 further includes a user session manager 124 configured to manage the user session between the user and the conversation agent 120. As used herein, the term “user session” includes all messages exchanged between a user and the conversation agent 120 during a given session initiated by either the user or the conversation agent 120 via an interactive communication platform 50. In an implementation, the user session manager 124 may retrieve a prior conversation history (stored in a user session database 126) between the user and the conversation agent 120. The prior user session information and message exchanges associated with the user and conversation agent 120 may be managed across multiple user devices 10, such that the user sessions between a user and the conversation agent 120 are tracked and stored, irrespective of the user device used by the user during the one or more prior user sessions.

In an implementation, the user session manager 124 may further maintain a log of all user sessions involving the conversation agent 120 and one or more users. In addition, the user session manager 124 may be configured to analyze the information extracted from the user sessions to generate analytics data. The user session manager 124 may store the user session log and analytics data in a log and analytics database 128.

The personalized content recommendation system 130 is configured to generate one or more personalized content recommendations for provisioning to a target user via the interactive communication platform 50. The personalized content recommendation system 130 is a software component (e.g., a set of instructions residing in a memory) executable by one or more processing devices to perform the personalized content recommendation generating activities described herein (e.g., the methods described in detail in connection with FIGS. 2-5). The instructions of the personalized content recommendation system 130 may reside in a memory including any suitable computer readable storage medium, such as volatile memory devices (e.g., random access memory RAM), non-volatile memory devices (e.g., flash memory), a magnetic hard disk, a Universal Serial Bus (USB) solid state drive, a local disk, an external disk, and/or other types of memory devices. Although illustrated in FIG. 1 as part of the Chatbot system 100, it is noted that the personalized content recommendation system 130 may be a standalone system operatively coupled to the Chatbot system 100.

The network of content sources 140 can include, for example, multiple candidate content recommendations that may be stored in one or more data stores that are coupled to the network 40. The Chatbot system 100 can include, for example, messages including the content recommendations that are accessed by an interactive communication platform user on various user devices.

The network 40 can include one or more local area networks (LAN), one or more wireless networks, one or more mobile communications networks, one or more wide area networks (WAN), such as the Internet, or similar communication systems, or combinations of such. The network 40 can include one or more networking and/or computing devices such as wired and wireless devices. In one implementation, not all computing devices executing the various systems, modules, and/or user devices 10 are directly connected to each other. The network 40 may be separate networks.

The Chatbot system 100 can be hosted on one or more machines. The machines can include for example, and are not limited to, any data processing device, such as a desktop computer, a laptop computer, a mainframe computer, a personal digital assistant, a server computer, a handheld electronic device, an IOT device, or any other device configured to process data.

A user device 10A-10N can be a computing device such as a server computer, a desktop computer, a set-top box, a gaming console, a television, a portable computing device such as, and not limited to, mobile telephones, personal digital assistants (PDAs), portable media players, netbooks, laptop computers, an electronic book reader, wearable electronic devices, an TOT device, and the like.

According to embodiments of the present disclosure, the content recommendation may take the form of a URL presented to the user in a message from the conversation agent via the interactive communication platform 50. In an implementation, the user may access the content recommendation via the network 40 by using the browser 16 of the user device 10. A redirect server (not shown) may be employed to redirect information (e.g., user activity) included in the communication from the user device 10 and provide the user activity information to the Chatbot system 100. The user activity information may include an interactive communication platform ID associated with the user, a Chatbot ID associated with the user, a content recommendation system ID associated with the user, a related system ID associated with the user, and the information about the underlying user activity (e.g., the link that was accessed, the time of the access, etc.)

Advantageously, user signals relating to the user's messaging exchanges with the conversation agent, the user activity with respect to the content recommendations, and information collected and maintained by the related systems in the related profiles are used to build a user profile uniquely representing that user (i.e., the Chatbot user profile). The Chatbot user profile may be stored in a user profile database 132 operatively coupled to the personalized content recommendation system 130.

In an implementation, the Chatbot system 100 identifies a Chatbot ID associated with a user engaged in a message exchange with the conversation agent 120. The Chatbot system 100 provides the Chatbot ID to the personalized content recommendation system 130 for use in generating a personalized content recommendation for the user, as described in greater detail below. In an implementation, the personalized content recommendation system 130 uses the Chatbot ID to identify the Chatbot user profile corresponding to the user engaged in the conversation with the conversation agent 120. The personalized content recommendation system 130 may use the Chatbot user profile to generate one or more content recommendations to provide to the conversation agent 120 for messaging to the user via the interactive communication platform 50.

In an implementation, the user may not yet be associated with a Chatbot user profile (i.e., a cold start scenario). In this implementation, the user may be prompted to provide information for use in authenticating or identifying the user, for the purposes of identifying a user profile maintained by a related system (i.e., a related profile). For example, the user may be prompted to provide a voice sample or other verifiable information that may be used by the Chatbot system 100 to communicate with a related system (e.g., another application on the user device 10, another network, etc.) to retrieve the user's related profile. Upon retrieval of the user's related profile, the information in the related profile may be used by the Chatbot system 100 to generate a Chatbot identifier and a Chatbot user profile.

The aforementioned identifiers (i.e., the interactive communication platform ID, the Chatbot ID, the content recommendation system ID, and the related system ID) are used by the Chatbot system 100 to manage the one or more user profiles associated with the user and provide the personalized content recommendations to the user, as described in greater detail below. As illustrated above, the user identifiers may be determined based on a review of the communications sent by the user via the interactive communication platform 50 and via the network 40 (e.g., web-based communications processed via the browser 16 of the user device 10).

In an embodiment of the present disclosure, the one or more user profiles (e.g., the Chatbot user profile, the one or more related profiles, etc.) include information relating to the user's messaging sessions (e.g., current and historical sessions) and other user activity (e.g., browsing history, purchase history, etc.). In addition, the user profiles may include information obtained using a tracking cookie configured to track, map and store user data relating to a user's digital content consumption across the web and multiple devices associated with the user. For example, the user cookie may track the user's implicit usage (e.g., documents actually read by the user) and provides data about the user's explicit choices (e.g., a user's choice of one or more content recommendation scopes). In an implementation, the user cookie may also be used to store the Chatbot user profile, including data about content the user has read and liked. In an implementation the user's tracked content consumption data can be mapped and stored as a user taste profile graph indicating the relative percentage of content types consumed by the user.

In an implementation, to ensure the user's privacy, the cookie may not include any personally identifying information. A UUID (universally unique identifier) number is generated and assigned to the user tracking cookie and is subsequently reused (rewritten to the user's cookie) by the user content identity profile upon user registration.

In an implementation, the user may register with one or more of the Chatbot system 100 (to create and obtain a Chatbot ID), the personalized content recommendation system 130 (to obtain the personalized content recommendation system ID), the interactive communication platform 50 (to obtain the interactive communication platform ID), and with a related system (to obtain the related system ID). Registering with these systems provides the user with a consistent consumption experience across platforms, applications, the web, devices, geographical location, and time. For example, duplicate content recommendations to the same user may be avoided if a user is registered and/or logged in to the Chatbot system. In an implementation, registration also enables the user to be notified about and sign up for additional content recommendation services. In another embodiment the user profile data can be stored on and accessed from a secure third party content recommendation server. In another embodiment the user can login to the personalized hub homepage using a third-party user identity (e.g., a social media login such as Facebook or Twitter user login).

In an implementation, the content database 134 may organize the candidate content recommendations based on one or more content recommendation scopes. A content recommendation scope is a grouping of content used to organize and/or constrain the content recommendation entities based on one or more content characteristics (e.g., a source of the content, a category associated with the content, a topic of the content, an author of the content, an algorithm type, etc.). In implementations, each content recommendation scope is associated with one or more scoped content recommendations identified in accordance with the aspects of the present disclosure.

FIG. 2 is a flow diagram of an exemplary implementation of a method 200 for processing and managing messages exchanged between a user and a conversation agent of a personalized content recommendation interactive communication platform 100. The method 200 may be performed by processing logic that may comprise hardware (circuitry, dedicated logic, etc.), software (such as is run on a general purpose computer system or a dedicated machine), or a combination of both. In an implementation, the method 200 may be performed by the Chatbot system 100 of FIG. 1 hosted by one or more computing devices.

In an implementation, prior to sending an initial message to the conversation agent of the Chatbot system, the user may activate the conversation agent by sending a subscription command or request addressed to the conversation agent, add the conversation agent to the user's social network or contact list, or join the conversation agent's dedicated content recommendation group. In an implementation, the user may “subscribe” to the conversation agent by connecting to the conversation agent via the interactive communication platform. Upon subscription to the conversation agent, the Chatbot system issues a unique Chatbot ID to the user, as described in greater detail below. In an implementation, the user may subscribe to a conversation agent that is associated with and particular to a related system. For example, the user may subscribe to an ESPN Chatbot which filters or scopes the conversations to sports related content. In this regard, the user may add to his or her contact list multiple contacts relating respectively to many different publishers, companies, services, websites, applications, and systems to enable engagement in conversations that are scoped to a particular genre, topic, category, knowledge area, product etc.

In block 201, a message is received from a user (via an interactive communication platform) directed to a username or identifier of the conversation agent (e.g., “Mr. Chatbot”). The received message may be provided by the interactive communication platform to the conversation agent of the Chatbot system via either a push or pull communication protocol.

In block 203, an interactive communication platform ID is extracted from the received message. The interactive communication platform ID provides information that uniquely identifies the user within the interactive communication system. For example, a user named John Doe may have an interactive communication platform user name of “JohnDoe” associated with the user's mobile device number (e.g., 888-888-8888). In an example, the user's interactive communication platform ID may be formed based on the user's user name, phone number, or combination thereof. In order to properly manage communication transmitted via the interactive communication platform, each user has a unique interactive communication platform ID which is included with each message sent to or from the user via the interactive communication system. For example, if a user sends a message to the Mr. Chatbot using the Kik interactive communication platform, the user's Kik interactive communication platform ID is associated with the message.

In block 203, the interactive communication platform ID is extracted from the incoming message from the user. In block 205, the extracted interactive communication platform ID is used to query a user session database to identify the user's Chatbot ID. If it is determined that the interactive communication platform ID is not associated with a Chatbot ID, the Chatbot system creates a Chatbot ID for the user and adds the Chatbot ID to the user session database, in block 207. In block 207, the Chatbot system may also create a Chatbot ID by prompting the user for information to use in identifying a related system ID associated with the user and a related system.

If it is determined a Chatbot ID exists for the user based on the query of the user session database using the messaging ID, the Chatbot ID is retrieved, in block 209. Upon retrieval of the Chatbot ID, the Chatbot ID is used to determine if there is a user session associated with the Chatbot ID. The user session may include a historical record of one or more conversations between the user having the Chatbot ID and the conversation agent. If, in block 211, it is determined that no user session is associated with the Chatbot ID, a new user session is created for the Chatbot ID. The new user session may then be loaded for the user, in block 213. If a user session associated with the Chatbot ID is identified, the identified user session is loaded for the user, in block 213.

According to implementations, a user session may include attributes and information relating to the user's interactions with the Chatbot system 100. This user session information may include, but not limited to, the Chatbot ID, a user name on the messaging platform, a messaging platform ID, a location of the user device, a date and time of the last conversation between the user and the conversation agent, a date and time of a first conversation between the user and the conversation agent, the conversation history between the user and the conversation agent including text, images, URLs, etc., content preferences associated with the user (e.g., categories, topics, search terms, etc.), and user activity associated with the user (e.g., clicked/viewed content history, engagement with prior recommendations, previous recommendations provided by the Chatbot system 100 that were not engaged with by the user, etc.).

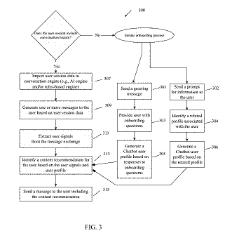

FIG. 3 is a flow diagram of an exemplary implementation of a method 300 for managing a user session between a user and the Chatbot system 100. The method 300 may be performed by processing logic that may comprise hardware (circuitry, dedicated logic, etc.), software (such as is run on a general purpose computer system or a dedicated machine), or a combination of both. In an implementation, the method 300 may be performed by the Chatbot system 100 of FIG. 1 hosted by one or more computing devices.

In method 300, a determination is made whether a user session includes a conversation history (e.g., a historical record of prior message exchanges between the user and the conversation agent). If the user session does not include a conversation history, the conversation agent initiates an onboarding process to capture and collect information about the user to generate a user profile. In block 301, during the onboarding process, the conversation agent sends a greeting message to the user. In block 303, the conversation agent sends one or more onboarding questions configured to collection information about the user's interests, preferences, activities, likes, dislikes, etc. For example, the onboarding questions may include, but are not limited to, prompts relating to preferred reading topics for the user (e.g., news, technology, sports, finance, trending topics, entertainment, etc.), preferred sources of information (e.g., leading publishers or websites, news channels, etc.), a location of the user device, a preferred language, etc. In an implementation, the conversation agent may provide the user with a list of conversational commands configured to guide the user through various optimal or exemplary interactions with the conversation agent.

In block 305, having collected the user's responses to the onboarding questions, the Chatbot system generates a user profile for the user. As detailed above, the user profile may be established and expanded based on the user sessions (e.g., conversations with the conversation agent) across multiple interactive communication platforms, the user activity (e.g., user interactions with the content recommendations provided by the Chatbot system, user web-based browsing and consumption histories, etc.). The Chatbot user profile is stored by the Chatbot system in a suitable data store (e.g., the user profile database 132 of FIG. 1) and accessible by the personalized content recommendation system to generate personalized content recommendations to provide to the user in a message via the interactive communication platform.

In an implementation, as part of the onboarding process in instances wherein a cold start is required (i.e., the user has no previous Chatbot ID, Chatbot user profile, or user session information), the Chatbot system may send the user a prompt for identifying information, in block 302. In an example, the prompt may include a request for the user to provide a voice sample. In block 304, the identifying information (e.g., the voice sample) may be processed and analyzed to identify a related profile associated with the user that is maintained by a related system. In an example, the voice sample may be converted to a character string and used to gain access to the related profile of a related system. In an implementation, the Chatbot system may communicate with one or more related systems and retrieve from the related system the related profile using the voice sample (or converted version of the voice sample) as authenticating information. In an implementation, the related system may provide direct access to the user profile by the Chatbot system. In another implementation, the Chatbot system may not have direct access to the related profile, but instead be provided with at least a portion of the related profile. For example, the Chatbot system may communicate with the Facebook application (i.e., the related system) stored on the user's device to obtain the user profile managed by the Facebook application (i.e., the related profile). In block 306, using information included in the related profile, the Chatbot system may generate a Chatbot user profile. The Chatbot user profile is then used by block 313 to generate content recommendations for the user.

In an implementation, if it is determined that the user session associated with the user includes a conversation history (i.e., a Chatbot user profile exists for the user), in block 307, the user session data including the conversation history is imported (e.g., by the user session manager 124 of FIG. 1) to a conversation engine (e.g., AI engine 122 or Rules-based engine 123 of FIG. 1). In block 309, the AI or rules-based engine generates one or more messages based on the user session data to provide to the user via the conversation agent. In an implementation, the AI or rules-based engine may analyze the user session data including messages received from the user during the active dialog with the conversation agent and the conversation history to generate the messages provided to the user.

In block 311, one or more user signals are extracted from the message exchange with the user. For example, the user may provide a message including various user signals (e.g., keywords) which may be extracted and used to determine an appropriate response.

In block 313, in view of the user signals and user profile, the Chatbot system identifies a content recommendation for the user. In an implementation, the content recommendation may be generated by a personalized content recommendation system operatively coupled to the conversation agent. For example, the conversation agent may send a request to the personalized content recommendation system including the user's Chatbot ID. In response, the personalized content recommendation system may use the Chatbot ID to look up or otherwise identify the user profile (including the user session data and user activity) associated with the user. Based on the user profile information, the personalized content recommendation system generates a content recommendation that is personalized to that particular user and provides the one or more personalized content recommendations to the conversation agent.

In block 315, the generated personalized content recommendations may be provided to the user via a message on the interactive communication platform. Advantageously, the content recommendation is presented as part of the ongoing conversation with the conversation agent. The content recommendation may be provided in a form that is consumable by the user, such as, for example, as a URL link to the content, a downloadable file, etc. The generated content recommendation may be in any suitable format, including but not limited to, text, audio, images, videos, etc. Appropriate natural language or other messages (e.g. text, audio, emoji etc.) may accompany and contextualize the content recommendations provided to each unique user during the course of a conversation session.

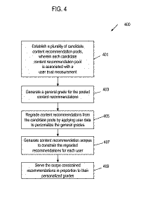

FIG. 4 is a flow diagram of an exemplary implementation of a method 400 for analyzing user profiles and their associated content recommendation scopes to generate personalized content recommendations from the content recommendation candidate pools for each user across multiple content serving locations and content usage scenarios. The method 400 may be performed by processing logic that may comprise hardware (circuitry, dedicated logic, etc.), software (such as is run on a general purpose computer system or a dedicated machine), or a combination of both. In an implementation, the method 400 may be performed by the personalized content recommendation system 130 of FIG. 1.

According to an implementation, the method 400 includes creating and/or identifying personalized content recommendations by building multiple pools of content recommendation candidates (e.g., candidate content recommendations may be considered based on a measure of a previously determined click-through-rate (CTR) and the features they best represent), in block 401. The “best” or optimized content recommendations in the content network are aggregated into a plurality of sets of content recommendation candidate pools, each pool being distinguished or classified based on a “user trust measurement” such as, for example, a user engagement measure, a high content recommendation quality metric, or based on a document property (e.g., the type or category of the document).

In an implementation, qualitative user trust measures may be determined based on one or more user trust signals identified at one or more of the following levels: a user level (e.g., based on the user profile, user action or activity history, an associated user cluster, etc.); a document level (e.g., a trustworthiness associated with the document, whether the document is considered evergreen content, etc.); and a source or context level (e.g., which section of a website the document appears in, a category associated with publisher source, a publisher, a language, a time of day, a day of the week, etc.).

In an implementation, the user trust measures may include, but are not limited to, one or more of the following: on-page user behavior events like scrolling and duration; average duration of user sessions on a content publisher's content; the number of documents/articles the user has viewed per session; the number of comments on an article; the percentage of article comments read by users; the number of return visits by the user to the content publisher's website over time in association with clicks by the user on the content recommendations provided on the content publisher's website; an indicator of content sharing by the user (e.g., copying the document's/article's URL by the user or clicking on the article's “share” button); a measure of the CTR associated with a document; the number of reads to end of article; an “evergreen” content recommendation associated with each document category; a best CTR by location; the number of document content recommendations or “likes” by other users, etc.

In an implementation, the system creates sets of pools of content recommendation candidates, each pool being associated with a user trust measurement. From the list of these sets of content recommendation candidate pools the system may match and choose suitable content recommendation candidates for each user profile. Advantageously, a scalable platform is provided for experimentation with different content recommendation candidate pools in order to increase user trust and engagement. The network-wide dispersal of the resulting content recommendation impressions affords valuable feedback and data on the quality of the content recommendations that can be used by the content recommendation service provider to further enrich and optimize the candidate content recommendation pools.

In one implementation, from a network-wide “whitelist” of content sources (i.e., content cleared by publishers for sharing on the content recommendation network), multiple types of candidate content recommendation pool sets may be generated. Such candidate content recommendation pool sets can include user trust signals or attributes that can be used to identify and cluster documents into the pool sets. Exemplary user trust signals or attributes may include: one or more “evergreen” content recommendations worldwide in English having a highest relative user engagement measure (e.g., CTR, maintaining user interest over time); content recommendations with the highest relative CTR for a particular geographic location and language; content recommendations with the highest relative CTR for a category and language; content recommendations with the highest relative CTR or RPM in a user cluster; content recommendations that have been allocated differing user trust thresholds for different classifications of users (e.g., classification of users by interests); and trending topics for a specific geographic location.

In an implementation, grades in each pool are normalized between sources. For example, a set of content recommendations may be generated, each with a prior grade and the set of “features” it was selected for (geography, category, source, etc.). Each document may also be tagged with a plurality of content recommendation pool metadata tags that can be used by the system to quickly generate new combinations and categories of content recommendation pools, if necessary.

In block 403, according to an implementation, a general grade may be generated for the set of all possible content recommendations in the pool based on one or more of a prior grade associated with the particular content recommendation and a user engagement measurement (e.g., CTR). In an embodiment, a prior grade is generated for the content recommendation. In an implementation, one or more content recommendations may be preselected based on previous performance in the network. In an implementation, a content recommendation's prior grade may represent an estimate of how well a content recommendation may perform in the future.

In an implementation, the general grade is based on an online-CTR for a particular content recommendation derived from aggregated user data associated with the network. In an embodiment, the current grade for a content recommendation is a combination of the prior grade and the actual CTR. The general grades may be personalized by assigning weights to the content recommendation pools in proportion to the user profile interest data that matches those pools. For example, if a user consistently chooses “evergreen” content over CTR driven content, the user may be associated with an “evergreen” content recommendation pools as a source of potential content recommendation candidates.

In block 405, according to implementations of the present disclosure, personal information associated with a particular user (e.g., user profile data including user session information relating to conversations with the conversation agent, one or more personal weights/constraints, etc.) may be considered in order to generate a personalized grade for a particular user. In implementations, the personalized grade may be an update, change, adjustment or re-calculation of the general grade in view of the personal information associated with the particular user. In an implementation, an actual CTR may be calculated for each content recommendation in the source. The actual CTR may then be combined with a prior grade associated with the content recommendation. In an embodiment, the user profile may be identified based on the cookie information and the user registration information. The grade for a content recommendation may then be re-graded or re-calculated in view of the user profile information.

In an implementation, a “relevance-to-user” measure associated with a particular content recommendation may be assigned on a per user basis to multiple users, for example, based on the best CTR/RPM in a user cluster from its profile. In an embodiment, a personalized grade generated in block 405 may be represented by the following expression:

personal_grade=relevance_to_user*general_grade

In an implementation, a content recommendation scope may be generated based on one or more of the following inputs: a document currently being viewed by the user (for which to show content recommendations); a source of the document; a UUID (from the user tracking cookie or user content profile); one or more current scopes; a number of scopes from each type to recommend; user interests data (taken from the user tracking cookie, e.g., visited categories and sources). Based on one or more of these inputs, a list of suggested content recommendation scopes is generated.

In one embodiment, as illustrated in FIG. 4, the method for serving content recommendation scopes may include one or more of the following operations: making a list of scopes with counts/weights (<EScope,String>=>Integer/Float); filling counts from the user tracking cookie; removing scopes deleted by the user.

In block 407, in an implementation, one or more content recommendation scopes may be generated to constrain the re-graded content recommendations for each user, in block 307. According to implementations of the present disclosure, a content recommendation scope is a content recommendation filter that presents the user with content recommendations conforming to the user's chosen scopes (also referred to as “scoped content recommendations”). In an implementation, the content recommendations may be filtered by one or more content recommendation scope parameters, such as, for example, by features the content recommendation was selected by (e.g., categories the user saw, user geographic location, scope preferences explicitly chosen or dismissed by the user, etc.).

In an implementation, a content recommendation may be filtered by its properties (e.g., categories, the content recommendation pool it came from, content sources, etc.), the user properties (e.g., categories, geographic location, etc.) and/or the current content recommendation scope the user is located within (e.g., information associated with a current web site or document that the user is consuming).

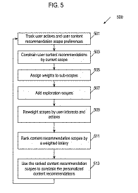

In block 409, according to an implementation of the present disclosure, content recommendations are then served to users in proportion to their personalized grades, as filtered by the user's user profile information and content recommendation scopes in block 407 (as described below in detail with reference to FIG. 5).

According to implementations of the present disclosure, the content recommendation served via a interactive communication platform by a conversation agent (e.g., conversation agent 120 of the Chatbot system 100) to a user may be a “nested” Chatbot recommendation. In this embodiment, a user interacting with a first conversation agent via an interactive communication platform may be served with a recommendation to link and subscribe to another conversation agent (e.g., a publisher, topic or product related conversation agent). For example, a user may be engaged in an interaction with the Chatbot system via an interactive communication platform. In light of the interaction with the user, the Chatbot system may determine that a personalized recommendation appropriate for the user is to link to and subscribe to a publisher-specific conversation agent (e.g., the CNN Chatbot).

FIG. 5 is a flow diagram of an exemplary implementation of a method 500 for using ranked content recommendation scopes to constrain personalized content recommendations, according to implementations of block 407 of FIG. 4. The method 500 may be performed by processing logic that may comprise hardware (circuitry, dedicated logic, etc.), software (such as is run on a general purpose computer system or a dedicated machine), or a combination of both. In an implementation, the method 500 may be performed by the personalized content recommendation system 130 of FIG. 1.

In an implementation, content recommendation scopes comprise a content taxonomy optimized to organize and constrain the served content recommendation entities (e.g., by source, category, topic, author, algorithm type etc.). This results in a themed stream of content being provided for personalized browsing by the user. In block 501, user data associated with the user's messaging activity and other user's action is tracked and analyzed to identify current and potential user recommendation scope preferences (e.g., a user's click on a scope implies actual interest in reading more content from that content recommendation scope).

In an implementation, users can employ explicit choices to configure the content recommendation scopes they prefer. The user can also delete or negate unwanted scopes, which will not be served to the user from then on. All such user preference data, including user scope preferences, are stored in the user profile and accessed by the content recommendation system whenever necessary, in block 501.

In an implementation, personalized content recommendations of scopes are generated by matching the user content profile (and its associated user tracking cookie or UUID) to content recommendation scopes that might interest the user. The selected personalized content recommendations are constrained based on a listing of ranked content recommendation scopes (wherein the ranked content recommendation scopes include exploration scopes, sub-scopes, current scope), in block 503. A current scope marks the user's location in a category. Exemplary content recommendation scopes include, but are not limited to: a category and sub category (e.g., “Tech”); a publisher and source (e.g., “CNN”); a topic (e.g., “Miley”), an algorithm, an author, a brand, etc.

Content recommendation scopes may be selected according to one or more selection rules, such as for example: recommending categories based on previously visited categories (e.g., if user has previously visited these categories, whether explicitly, or implicitly by viewing documents, show these categories, selected by weight); recommending categories and super categories based on current scope (e.g., super category vs. category) and previously visited categories (e.g., identifying previously visited super categories from visited categories); recommending related categories (e.g., by using a static or dynamic relation matrix) to categories visited by user; recommending categories using multiple algorithms (e.g., exploration, exploitation, based on user interests, related to content, related to user interests, collaborative filtering, clustering and other algorithms). In an implementation, one or more algorithms may be used to provide a confidence measure for itself, so the resulting content recommendation scopes can be weighted accordingly. Given more data about the user, the weight assigned to personal algorithms increases incrementally, with the weight assigned to contextual or exploration algorithms decreasing in proportion.

In an implementation, identifying collaboratively filtered content recommendations based on user activity data collected from users in an electronic environment is disclosed. The user activity data may include information relating to user-engagement indications of the users. Multiple connection pairs are identified based on the user activity data, with each connection pair including a potential target document and a candidate recommendation document. A connection strength is determined for each of the identified connection pairs. An overall grade is generated for a set of candidate connection pairs of the plurality of connection pairs, wherein the overall grade is based on the respective connection strength associated with each of the set of candidate connection pairs. One or more filtered recommendations for provisioning in connection with the target document based on a comparison of the overall grade associated with each of the set of candidate connection pairs.

In an implementation, the Chatbot system may assign yield and revenue values to web page content in real time. The method may include providing a script component and an application server, prompting a content source (e.g. a publisher) to embed the script component into a web page, analyzing the metadata of the web page, sending, based at least in part on the content metadata and the visitor metadata, the event to the application server, analyzing the event, determining, based at least in part on the event, the one or more content recommendations that would be displayed on the web page, and determining a revenue data based on the one or more content recommendations.

Additionally, an exploration algorithm (e.g., popular, trending, editor pinned content etc.) allows surfacing new content recommendation scopes for the user to explore. The user's implicit interactions with the surfaced exploration content recommendation scopes (e.g., multiple content recommendation scopes with different weights) generate accurate and valuable data on what the user really wants to read or interact with. The exploration content recommendation scopes can also be used to learn about the content preferences of new readers, for whom there is insufficient historical data.

According to an implementation, a server (e.g., the personalized content recommendation system 130 of FIG. 1) assigns a content recommendation to the exploration group. The exploration group may include a group of recommendations that may be newly added to the personalized content recommendation system. In an embodiment, the server creates data for the recommendation using exploration. For example, the exploration can include serving the recommendation for a time period and/or for a number of servings in a set of contexts (e.g., documents, document positions, sources, categories, sections, etc.) to create data relating to the recommendation's performance in different contexts. The configuration data can specify the period of time and/or the number of servings that the server should use during the exploration phase. In one implementation, the server performs exploration by using a prior understanding or historical data of “where” (e.g., content locations) similar content recommendations performed well. For example, a content recommendation may be related to politics. In this example, historical data may be identified that indicates that recommendations about politics generally perform well in business sources (i.e., a location), and, based on that historical data, the server can serve the content recommendation in one or more business sources (e.g. serve content on politics to a user browsing business content).

In an implementation, the server may divide the subset of content recommendations into a non-exploration group and an exploration group. The non-exploration group can include recommendations that have a CTR value that is based on measured data for the corresponding recommendation. The exploration group can include content recommendations that have a CTR value that is based on data that is created by testing the corresponding recommendation in one or more contexts or destinations (e.g., documents, sources, etc.). The recommendations in the exploration group may have little or no measured data. For example, the recommendations in the exploration group may be new recommendations that have not been served as impressions for documents or that have been served as impressions only a few times (e.g., a number of impressions that falls below a threshold value that is set within the system).

In an implementation, in block 503, the method may further include adding a current scope to counts according to one or more of the following rules: if the current scope is a category, adding the category with a predefined weight (e.g., 15), and also adding its super category with predefined weight (e.g., 10); if the current scope is a super category, adding its categories with predefined weights (e.g., 3), in block 505.

In an implementation, in block 507, one or more exploration or experimental scopes may be added (e.g., 3N exploration scopes) for exploration each with total predefined weight (e.g., 1). In an implementation, in block 509, user content consumption data from the user taste profile graph is used to reweight the list of scopes in proportion to the percentage of the user's consumption of different content types as recorded in the user taste profile graph. In an implementation, the system may pick a number of scopes (e.g., N scopes), which can be categories, super categories, etc., by a weighted lottery, in block 511. In block 513, the weighted content recommendation scopes may be used to filter the graded content recommendations.

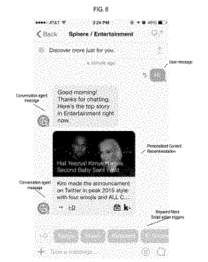

FIG. 6 is an exemplary screenshot of a conversation between a user and the conversation agent of the Chatbot system via an interactive communication platform (e.g., Kik). As shown in FIG. 6, the user (identified by the letter “R” and the message bubbles appearing on the right hand side of the message display interface) is engaged with the conversation agent (identified by a symbol and the message bubbles appearing on the left hand side of the message display interface). As shown, the conversation agent responds to the user's greeting (“Hi”) by providing a personalized content recommendation relating to a topic identified as being of interest to the user (e.g., a top entertainment story). The user may interact with the message to access the article relating to the message.

In an implementation, the Chatbot system may present the user with one or more keyword filters that may be used to further refine the user profile and determine the user's preferences. The keyword filters may be related to the current conversation, a content recommendation, or both. As shown in the example in FIG. 6, the user is presented with a number of keyword filters (e.g., “Kanye”, “Music”, “Billboard”, “E! Online”). The user may select a keyword from the list and the selection may be used by the Chatbot system to trigger or determine a next message, an action, a content recommendation, a next set of keyword filters, or a combination thereof. The keyword filter selection received from the user may also be added to the user profile.

In an implementation, the interactive communication platform may present the user with a recommendation for using another Chatbot (i.e., a conversation agent configured in accordance with rules, filters, and content relating to a publisher (e.g., CNN) or a topic (e.g., politics), in accordance with the user's search intentions and user profile data analysis.

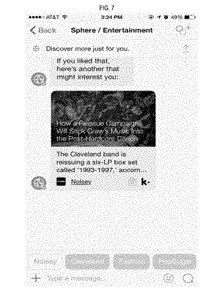

FIG. 7 is an exemplary screenshot of an active conversation between a user and the conversation agent of the Chatbot system. In this example, the conversation agent may initiate a conversation with the user (based on the user's preferences) and provide a personalized content recommendation to the user. In an implementation, the user may set preferences regarding the automated delivery of content recommendations. For example, the user may indicate a preferred time of day to receive content recommendation messages, one or more preferred sources relating to the content of the content recommendation (e.g., a user may only wish to receive messages of this type if the source of the content is a particular publisher), etc.

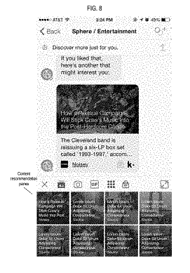

FIG. 8 is an exemplary screenshot of an active conversation between a user and the conversation agent of the Chatbot system including multiple content recommendation panes. In this example, the Chatbot system serves the multiple content recommendations via the multiple recommendation panes positioned at or near a bottom of the interactive communication platform display. The user may select any one of the content recommendation panes to access the corresponding content. Alternatively, the content recommendation may be served in a content tile carousel or such similar user interface designs.

According to implementations of the present disclosure, a user may establish his or her preferences relating to the messaging and conversations with the conversation agent of the Chatbot system. For example, the user may request that content recommendations be provided by the Chatbot system in response to the user's messaging history, location, time of day, day of the week, or other similar data.

In an implementation, interaction with a personalized content recommendation link via the interactive communication platform may transport the user to a framed webpage article overlaid onto the interactive communication platform display, providing another option for browsing the one or more personalized content recommendations.

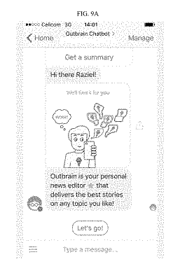

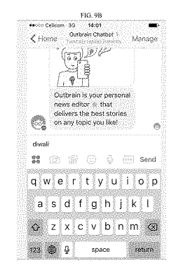

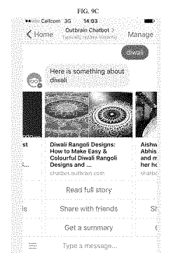

FIGS. 9A-9C illustrate an exemplary graphical user interface associated with the Chatbot system. In the examples shown, an interface enabling a conversation (e.g., an exchange of messages) between a conversation agent of the Chatbot system and a user (e.g., user “Raziel” in FIGS. 9A-9C). FIGS. 9A-9C further illustrate an example conversation wherein the Chatbot system greets the user, receives a conversational input from the user of “Diwali,” and returns a plurality of content recommendations related to the conversation (e.g., related to “Diwali”). FIG. 9C further illustrates a number of options available to the user as it relates to the content recommendations provisioned in view of the conversation, including, but not limited to, an option to read the full story, share the story with friends, get a summary, and/or continue the conversation.

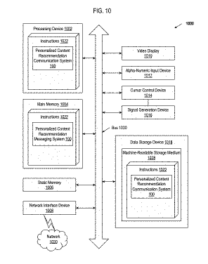

FIG. 10 is a block diagram of an example computer system 1000 that may perform one or more of the operations described herein, in accordance with various implementations. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a VR or AR display, a web appliance, a server, a network router, switch or bridge, an IOT device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (e.g., a processor) 1002, a main memory 1004 (e.g., read-only memory (ROM), flash memory, dynamic random access memory (DRAM) such as synchronous DRAM (SDRAM), double data rate (DDR SDRAM), or Rambus DRAM (RDRAM), etc.), a static memory 1006 (e.g., flash memory, static random access memory (SRAM), etc.), and a data storage device 1018, which communicate with each other via a bus 1030.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1022 for performing the operations and steps discussed herein.

The computer system 1000 may further include a network interface device 1008. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1016 (e.g., a speaker).

The data storage device 1018 may include a computer-readable storage medium 1028 on which is stored one or more sets of instructions 1022 (e.g., software) embodying any one or more of the methodologies or functions described herein. The instructions 1022 may also reside, completely or at least partially, within the main memory 1004 and/or within the processor 1002 during execution thereof by the computer system 1000, the main memory 1004 and the static memory 1006 also constituting computer-readable storage media. The instructions 1022 may further be transmitted or received over a network 1020 via the network interface device 1008.

In one implementation, the instructions 1022 include instructions for an optimization module (e.g., personalized content recommendation interactive communication platform 100 in FIG. 1) and/or a software library containing methods that call the optimization module. While the computer-readable storage medium 1028 (machine-readable storage medium) is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “identifying”, “generating”, “transmitting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

The terms “first”, “second”, “third”, “fourth”, etc. as used herein are meant as labels to distinguish among different elements and may not necessarily have an ordinal meaning according to their numerical designation.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, via an interactive communication platform operatively coupled to a first conversation agent, a first message of an interactive conversation with a user, wherein the first message comprises a conversational input from the user;
identifying, by the processing device, a user profile associated with the user;
generating, by the processing device, a personalized content recommendation for the user from a plurality of content pools, based at least in part on the conversational input and the user profile associated with the user; and
transmitting, via the interactive communication platform to the user, a response message comprising the personalized content recommendation.

2. The method of claim 1, further comprising:
exchanging a plurality of additional conversational messages with the user; and
updating the user profile in view of the plurality of additional conversational messages with the user.

3. The method of claim 1, further comprising:
exchanging a plurality of additional conversational messages with the user; and
generating a second personalized content recommendation for the user from the plurality of content pools, based at least in part on the plurality of additional conversational messages, and the user profile associated with the user.

4. The method of claim 1, wherein identifying the user profile further comprises:
generating the user profile in view of an exchange with the user of a plurality of onboarding questions and answers.

5. The method of claim 1, wherein identifying the user profile further comprises:
prompting the user for identifying information;
establishing a communication with a related system;
providing the identifying information to the related system, wherein the related system uses the identifying information to authenticate the user;
in response to authentication of the user, receiving, from the related system, a related profile associated with the user and the related system;
generating the user profile based at least in part on the related profile.

6. The method of claim 1, wherein identifying the user profile further comprises:
receiving a user identifier as part of the first message; and
performing a look up in a database using the user identifier to identify the user profile.

7. The method of claim 1, wherein the personalized content recommendation comprises information identifying a second conversation agent associated with at least one of a publisher, topic, service or product.

8. The method of claim 7, wherein the information identifying the second conversation agent comprises a link to an interface of the second conversation agent.

9. The method of claim 1, wherein the first message comprises at least one of text, audio, video or a physical gesture.

10. The method of claim 1, wherein the interactive communication platform comprises at least one of an application interface or a web-based interface.

11. A system comprising:
a memory to store instructions; and
a processing device operatively coupled to the memory, the processing device to execute the instructions to:
receive, via an interactive communication platform operatively coupled to a first conversation agent executed by the processing device, a first message of an interactive conversation with a user, wherein the first message comprises a conversational input from the user;
identify a user profile associated with the user;
generate a personalized content recommendation for the user from a network of high quality content pools, based at least in part on the first message and the user profile associated with the user; and
transmit, via the interactive communication platform to the user, a response message comprising the personalized content recommendation.

12. The system of claim 11, the processing device to:
exchange a plurality of additional conversational messages with the user; and
update the user profile in view of the plurality of additional conversational messages with the user.

13. The system of claim 11, the processing device to:
exchange a plurality of additional conversational messages with the user; and
generate a second personalized content recommendation for the user from the plurality of content pools, based at least in part on the plurality of additional conversational messages, and the user profile associated with the user.

14. The system of claim 11, the processing device to:
generate the user profile in view of an exchange with the user of a plurality of onboarding questions and answers.

15. The system of claim 11, the processing device to:
prompt the user for identifying information;
establish a communication with a related system;
provide the identifying information to the related system, wherein the related system uses the identifying information to authenticate the user;
in response to authentication of the user, receive, from the related system, a related profile associated with the user and the related system;
generate the user profile based at least in part on the related profile.

16. The system of claim 11, the processing device to:
receive a user identifier as part of the first message; and
perform a look up in a database using the user identifier to identify the user profile.

17. The system of claim 11, wherein the personalized content recommendation comprises information identifying a second conversation agent associated with at least one of a publisher, topic, service or product.

18. The system of claim 17, wherein the information identifying the second conversation agent comprises a link to an interface of the second conversation agent.

19. The system of claim 11, wherein the interactive communication platform comprises at least one of an application interface or a web-based interface.

20. A non-transitory computer readable storage medium comprising instructions that, if executed by the processing device, cause the processing device to:
receive, via an interactive communication platform operatively coupled to a first conversation agent executed by the processing device, a first message of an interactive conversation with a user, wherein the first message comprises a conversational input from the user;
identify a user profile associated with the user;
generate a personalized content recommendation for the user from a network of content pools, based at least in part on the first message and the user profile associated with the user;
transmit, via the interactive communication platform to the user, a response message comprising the personalized content recommendation;
exchange a plurality of additional conversational messages with the user;
update the user profile in view of the plurality of additional conversational messages with the user; and
generate a second personalized content recommendation for the user from the plurality of content pools, based at least in part on the plurality of additional conversational messages, and the user profile associated with the user.
